(19) United States
(12) Patent Application Publication
(10) Pub. No.: US 2006/0050708 A1
(43) Pub. Date: Mar. 9, 2006

(54) Transmitting information between a transmitting device and a receiving device in a communication system

(76) Inventors: Israel Shapiro, Yokneam (IL); Simcha Aronson, Raanana (IL); Etan Shirron, Raanana (IL)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/207,640

(22) Filed: Aug. 19, 2005

Related U.S. Application Data
(60) Provisional application No. 60/602,734, filed on Aug. 19, 2004.

(51) Int. Cl. H04L 12/56

(52) U.S. Cl. 370/394

(57) ABSTRACT

A method transmits information in a communication system. The method includes transmitting information from a transmitting device to a receiving device through a communication channel, checking whether the receiving device has received the information without errors, and transmitting an acknowledgement notification from the receiving device to the transmitting device if the receiving device has received the information without errors. The acknowledgement notification includes an indication of a capability of the receiving device to receive further information from the transmitting device.

### CROSS-REFERENCE TO RELATED APPLICATIONS

This Non-Provisional Application claims the benefit of the filing date of Provisional U.S. Patent Application Ser. No. 60/602,734, entitled “METHOD FOR TRANSMITTING INFORMATION BETWEEN A TRANSMITTING DEVICE AND A RECEIVING DEVICE IN A COMMUNICATION SYSTEM AND RESPECTIVE COMMUNICATION SYSTEM,” having Attorney Docket No. I435.112.101/14552US, and having a filing date of Aug. 19, 2004, and which is herein incorporated by reference.

### BACKGROUND

There are many methods for transmitting information between a transmitting device and a receiving device in a communication system, such as a wireless communication system according to the Ultra-Wideband (UWB) technology. One example method is defined by a multiband OFDM alliance (MBOA) communication system.

According to the present standard for the media access controller (MAC) layer for MBOA communication systems, there is only provided a minimum flow control mechanism for burst acknowledgements. This flow control mechanism is based only on the MAC layer buffer size information, but does not allow the higher networking layers above the MAC layer to actively participate in the flow control mechanism.

Furthermore, in the MBOA MAC layer, there is not only a burst acknowledgement mode for frame acknowledgement, but also an immediate acknowledgement mode and a no-acknowledgement mode. In the immediate acknowledgement mode, the receiver sends an immediate acknowledgement frame to the transmitter after it has received a frame without errors from the transmitter. In the burst acknowledgement mode, the receiver sends a burst acknowledgement frame after having received a frame with a burst acknowledgement request from the transmitter. The burst acknowledgement frame lists all the previous frames of the burst acknowledgement type that were received without errors. Finally, in the no-acknowledgement mode, the receiver does not send any acknowledgement frames to the transmitter even if a correct frame has been received. This acknowledgement scheme is in particular appropriate for multicast or broadcast frames, because it is hard and inefficient to support acknowledgements from multiple sources.

Therefore, there is a need for a full and unified acknowledgement scheme to perform MAC and higher layer flow control for all acknowledgement types.

### SUMMARY

One aspect of the present invention provides a method of transmitting information in a communication system. The method includes transmitting information from a transmitting device to a receiving device through a communication channel. The method includes checking whether the receiving device has received the information without errors. The method includes transmitting an acknowledgement notification from the receiving device to the transmitting device if the receiving device has received the information without errors. The acknowledgement notification comprises an indication of a capability of the receiving device to receive further information from the transmitting device.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a simplified block diagram of a communication system according to one embodiment.

FIG. 2 illustrates an example format for an immediate acknowledgement frame according to one embodiment.

FIG. 3 illustrates an example format of a burst acknowledgement frame according to one embodiment.

FIG. 4-FIG. 7 illustrate examples for primitives for supporting a flow control in accordance with various embodiments.

FIG. 8 is a chart illustrating a flow control mechanism according to one embodiment.

FIG. 9 and FIG. 10 illustrate embodiments of primitives for queue polling.

FIG. 11 illustrates an example format of a queue polling control frame according to one embodiment.

FIG. 12 and FIG. 13 illustrate embodiments of primitives for queue polling.

FIG. 14 illustrates an example format for a queue polling command frame according to one embodiment.

FIG. 15 illustrates a representation of a queue polling command frame format according to one embodiment.

FIG. 16 is a chart illustrating a complete flow control mechanism including queue polling in accordance with one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

A method is disclosed for transmitting information between a transmitting device and a receiving device in a communication system as well as a respective communication system which provides such a full and unified acknowledgement scheme.

In one embodiment, an example method transmits information between a transmitting device and a receiving device in a communication system. This example method transmits information from the transmitting device to the receiving device, checks whether the receiving device has received the information without errors, and transmits an acknowledgement notification from the receiving device to the transmitting device if the receiving device has received the information without errors. The acknowledgement notification in this example method comprises an indication on a capability of the receiving device to receive further information from the transmitting device.

In one embodiment, the communication between the transmitting device and the receiving device is carried out on a frame basis, and consequently the receiving device sends the acknowledgement notification to the transmitting device after having received a frame without errors from the transmitting device. Depending on the respective acknowledgement mode, the acknowledgement notification can comprise an acknowledgement of the immediate acknowledgement type or burst acknowledgement type.

In one embodiment, the acknowledgement notification comprises information on a maximum number of additional frames (not depending on the frame size) which can be handled by the queue comprising a buffer of the receiving device. Furthermore, the acknowledgement notification can also comprises an information on the free buffer size of the receiving device's buffer.

In one embodiment, the communication information and the acknowledgement notification are transmitted on the MAC layer between the transmitting device and the receiving device. One embodiment of a mechanism forwards the acknowledgement notification from the MAC layer to higher layers. One embodiment of a mechanism performs queue polling, which allows the higher networking layers above the MAC layer at the transmitting device to check the status of specific queues at the receiving device.

Embodiments of the present invention can be used in MBOA communication systems according to the UWB technology. However, as a matter of course, the present invention is not restricted to this field of technology, but may be applied to all transmission standards with acknowledgement notifications, such as Hiper-LAN, Ethernet or USB. Furthermore, one embodiment of a mechanism of the present invention can be used for supporting asynchronous and isochronous flows and allows a full and unified scheme to perform MAC layer flow control as well as higher layer flow control for all acknowledgment types, including the burst acknowledgement type, the immediate acknowledgment type, and the no-acknowledgement type.

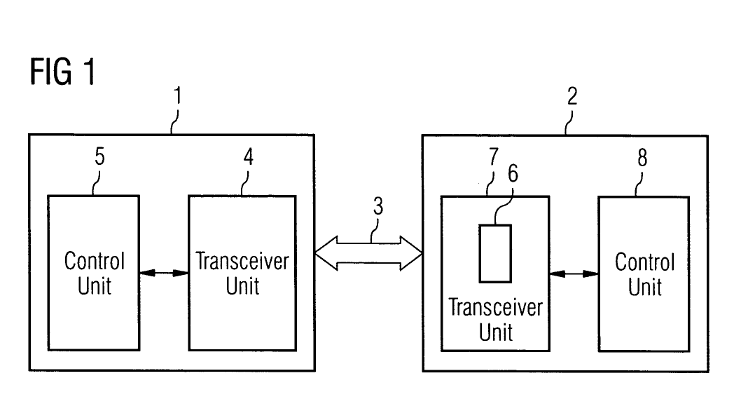

FIG. 1 illustrates one embodiment of a communication system (e.g., a wireless communication system according to the MBOA transmission standard) which comprises a transmitting device 1 and receiving device 2. The transmitting device 1 and the receiving device 2 are coupled by a transmission channel/transmission link and comprise each a transceiver section 4, 7 for transmitting and receiving information from the respective other device. Furthermore, both devices comprise a control unit 5, 8 for controlling the functionality and operation of the respective device. The receiving device 2 comprises in its transceiver section 7 a queue with a buffer 6 for buffering communication frames which the receiving device 2 receives from the transmitting device 1 through the communication channel 3. The communication information transmitted from the transmitting device 1 to the receiving device 2 may comprise data as well as audio and video information.

In one embodiment, the communication system illustrated in FIG. 1 provides a full and unified scheme to perform MAC and higher layer flow control of all acknowledgement types, including acknowledgements of the burst acknowledgement type (burst-ACK), immediate acknowledgement type (immediate-ACK), and no-acknowledgement type (no-ACK). Furthermore, one embodiment of the communication system is also arranged such that both asynchronous and isochronous flows can support flow control with the mechanisms described in the following.

As already mentioned above, the communication information is transmitted from the transmitting device 1 to the receiving device 2 in the form of a sequence of a plurality of communication frames. The communication information received by the receiving device 2 is buffered in the buffer 6 and, thereafter, processed and evaluated by the control unit 8 of the receiving device 2.

In one embodiment, the control unit 8 of the receiving device 2 checks whether the communication information has been received from the transmitting device 1 without errors. The error checking can be performed by using any suitable error checking algorithm (e.g., CRC (cyclic redundancy check) error checking). If the communication information has been received from the receiving device 2 without errors, the control unit 8 controls the transceiver unit 7 of the receiving device 2 such that an acknowledgement notification is transmitted from the transceiver unit 7 of the receiving device 2 to the transmitting device 1, the acknowledgement notification informing the transmitting device 1 on the correct receipt of the communication information.

In one embodiment, the process of sending the acknowledgement notification from the receiving device 2 to the transmitting device 1 depends on the respective acknowledgement mode as implemented in the given embodiment of the communication system. In the immediate acknowledgement mode for one example embodiment, the receiving device 2 sends an immediate acknowledgement frame as the aforesaid acknowledgement notification to the transmitting device after it has received a complete communication frame without errors from the transmitting device. In the burst acknowledgement mode for this example embodiment, the receiving device 2 sends a burst acknowledgement frame to the transmitting device 1 after having received a communication frame with an explicit burst acknowledgement request from the transmitting device 1. The burst acknowledgement frame lists all the previous communication frames of the burst acknowledgement type that were received by the receiving device 2 without errors. Finally, in the no-acknowledgement mode for this example embodiment, the receiving device 2 does not send any acknowledgement frames or acknowledgement notifications to the transmitting device 1 even if a correct communication frame has been received.

In the following embodiments, however, it is assumed that an acknowledgement notification, either according to the immediate acknowledgement type or according to the burst acknowledgement type, is sent from the receiving device 2 to the transmitting device 1, thereby notifying the transmitting device 1 of the correct receipt of a communication frame through the communication channel 3, and in particular the acknowledgement notification comprises information on the capability of the receiving device 2 to receive further communication information from the transmitting device 1. In other words, with the acknowledgement notification the receiving device 2 informs the transmitting device 1 whether it has sufficient capacity to receive further communication frames from the transmitting device 1.

In one embodiment, the acknowledgement notification comprises information on a maximum number of additional communication frames which can be received by the receiving device from the transmitting device, and consequently it is beneficial if the acknowledgement notification comprises information on the free buffer size of the buffer of the queue 6 of the receiving device 2, which is available for receiving further communication frames or communication information from the transmitting device.

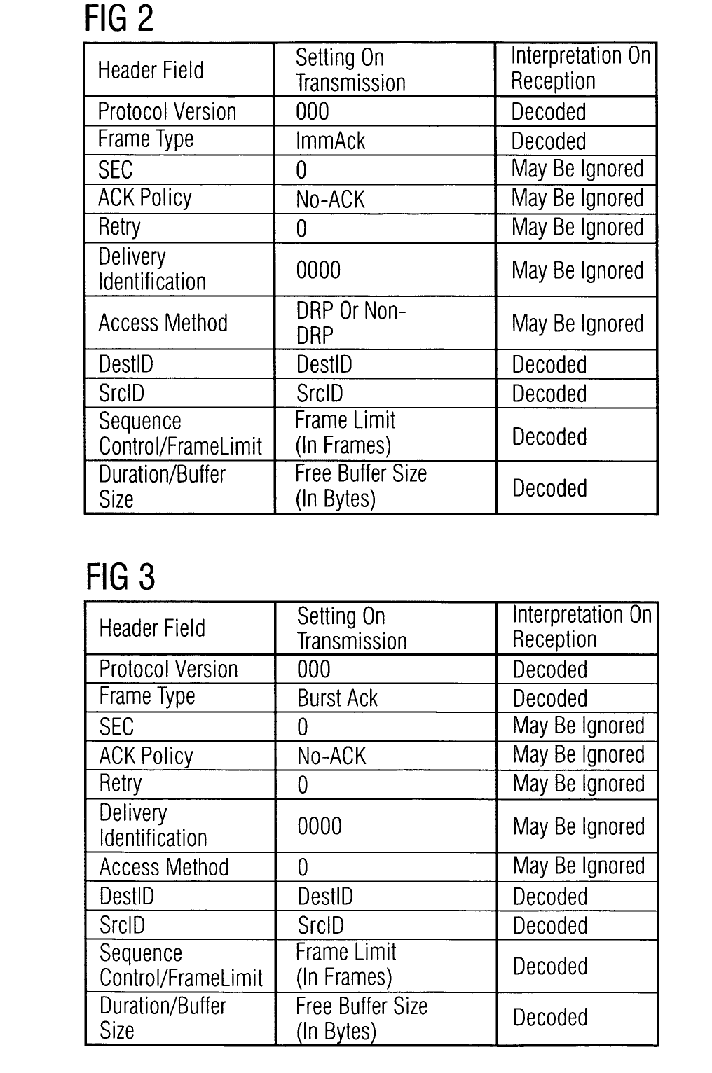

FIG. 2 illustrates one embodiment of an example format of an immediate acknowledgement frame, the frame comprising a header field with a plurality of control fields as indicated in the first column of the format illustrated in FIG. 2. In other words, the first column of the format of FIG. 2 includes the names or meanings of the individual control fields. The second column of FIG. 2 includes the settings of these control fields upon transmission, and the third column of FIG. 2 includes an indication whether the respective control field is to be decoded or may be ignored from the MAC of the receiving communication device. Except for the last two control fields, the remaining control fields have been taken from the current MBOA MAC standard which is hereby incorporated by reference.

The control field “Protocol version” defines the version of the transmission protocol, while the control field “Frame type” defines the type of the acknowledgement frame with “ImmAck” designating an immediate acknowledgement frame. The control field “SEC” is the security bit in the MBOA MAC frame header and defines if the frame payload is encrypted or not. The control filed “ACK policy” defines the acknowledgement policy, while the control field “Retry” indicates whether the present acknowledgement frame is a re-transmitted acknowledgement frame or not. The control field “Delivery Identification” identifies during the transmission the acknowledgement frame itself, and the control field “Access method” defines whether the transmission is in accordance with the distributed reservation protocol (DRP) or not (DRP means that the transmission time is guaranteed and respected by other communication devices in the vicinity). The control fields “DestID” and “SrcID” define an identifier for the destination device and the source device, respectively.

In addition to the above-described control fields, the example immediate acknowledgement frame illustrated in FIG. 2 also includes two additional control fields “Sequence Control/Frame Limit” and “Duration/Buffer size”. The control field “Sequence Control/FrameLimit” defines the maximum number of additional communication frames which the queue 6 of the respective communication device sending the immediate acknowledgement frame can handle. The control field “Duration/Buffer size”, on the other hand, defines the free buffer size (in bytes) which the queue 6 of the respective communication device sending the immediate acknowledgement frame can handle. Both control fields are employed for the communication device receiving the immediate acknowledgement frame so as to know whether the respective other communication device can handle further communication frames.

FIG. 3 illustrates an example of a new format for a burst acknowledgement frame in accordance with one preferred embodiment.

As can be seen from a comparison between FIG. 3 and FIG. 2, the format of the burst acknowledgement frame is substantially similar to the format of the immediate acknowledgement frame, except for the control field “Frame type” which now has the value “Burst Ack” indicating the burst acknowledgement frame type. As regards the other control fields of the header field of the burst acknowledgement frame, reference can be made to the above explanations with respect to FIG. 2.

In order to allow the networking layers above the MAC layer to support flow control, embodiments add new MAC-SAP (service access point) primitives and to change the existing ones respectively for the software-based control of the communication between the transmitting device 1 and the receiving device 2, these primitives in particular being used by the respective control units 5, 8 for the software-based control of the transmission of the communication frames between both communication devices. As regards the existing MAC-SAP primitives, reference can again be made to the current MBOA MAC standard and the respective explanations thereof on these primitives and the fields thereof, which is hereby incorporated by reference.

As regards the existing primitives, a parameter “BufferSize” indicating the free buffer size and a new parameter “FrameLimit” indicating the maximum number of additional frames are added to the existing confirmation primitives to support higher layer flow control at the transmitting side. The indication primitives at the receiving side do not include the frame data itself. They are used to indicate data arrival only.

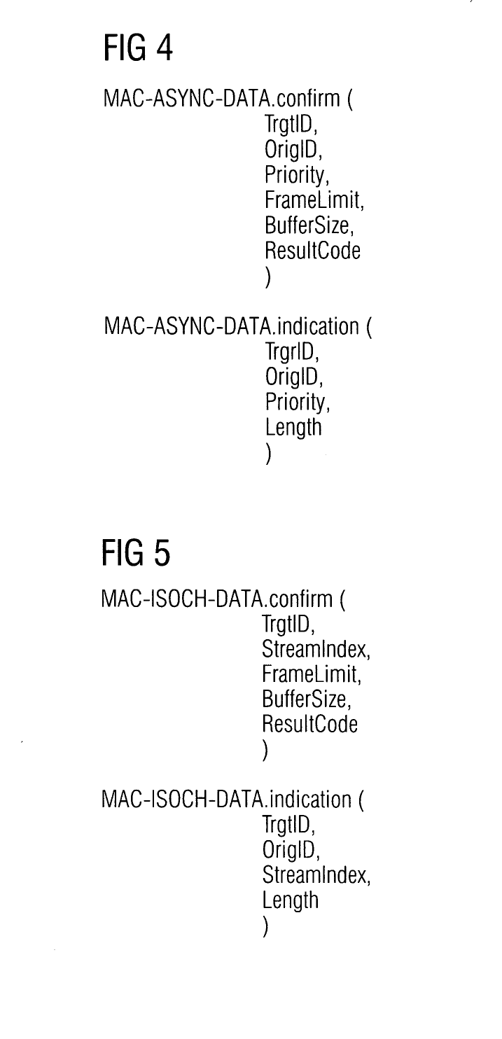

FIG. 4 illustrates example new format for the confirmation primitive MAC-ASYNC-DATA.confirm and the new indication primitive MAC-ASYNC-DATA.indication for asynchronous data flows in accordance with one embodiment. The new fields “FrameLimit” and “BufferSize” have already been explained above. Furthermore, the confirmation primitive includes the field “TrgtID” which identifies the target device (that is the receiving device) as stated in the respective MAC header. Furthermore, both primitives include the field “OrigID” which identifies the originating device as stated in the respective MAC header. The field “Priority” describes the user priority as defined in the MAC header of the communication frames, and in particular the field “Priority” may define a specific receiving queue for processing the communication frames. The field “ResultCode” of the confirmation primitive includes a value for indicating a result of a requested operation, and for example the value of this field may be “succeeded”, “failed”, “blocked” etc. Finally, the field “Length” of the indication primitive indicates the length of the respective communication frame in bytes.

FIG. 5 illustrated in a similar manner an example new format of the confirmation primitive MAC-ISOCH-DATA.confirm and the indication primitive MAC-ISOCH-DATA.indication for isochronous data flows in accordance with one embodiment. The confirmation primitive illustrated in FIG. 5 again includes the fields “FrameLimit” and “BufferSize” similar to the confirmation primitive for asynchronous data flows as illustrated in FIG. 4. Furthermore, the confirmation primitive for isochronous data flows includes a field “StreamIndex” which is already known from the current MBOA MAC standard. For frames that use the DRP allocation type, it is possible to support different data streams between the same communication devices. The “StreamIndex” parameter differentiates between different data flows that belong to the same transmitting and receiving device. The “StreamIndex” field is also included in the indication primitive illustrated in FIG. 5.

Additional primitives can be employed to support higher layer back-pressure at the receiving side. The higher layers are notified when a new data frame arrives. The higher layers request a frame from a queue and receive a response containing the frame data. In case the frame data is invalid, this will be indicated to the respective other communication device by means of the “ResultCode” field.

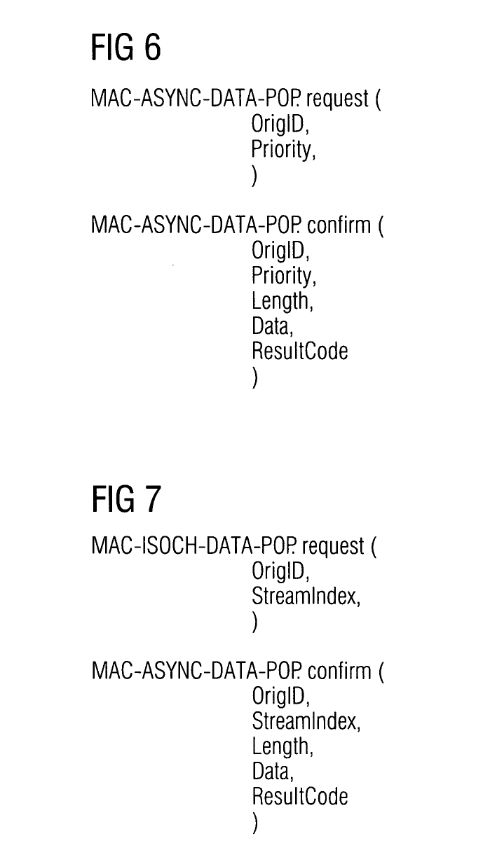

FIG. 6 illustrates an example new MAC-SAP primitives for asynchronous data flows. The new primitives comprise a new request primitive MAC-ASYNCH-DATA-POP.request and a new confirmation primitive MAC-ASYNCH-DATA-POP.confirm in accordance with one embodiment. The request primitive is used to request a new data frame via the respective control unit 8 from the respective queue, the parameters/control fields of the request primitive having already been discussed before. The new confirmation primitive is used to indicate to the MAC layer whether the frame data is valid or not. The confirmation primitive comprises a “DATA” field which is the actual data of the data frame. Furthermore, it comprises a field “Length” which defines the length of the data frame in bytes, and a field “ResultCode” which includes, as already discussed before, information on the result of the requested operation and, for example, can include the values “succeeded”, “failed”, “blocked” etc. The “OrigID” field of both new primitives defines the originating device as stated in its MAC header, and the field “Priority” defines the user priority as defined in the MAC header of the respective frame and indicates a specific receiving queue. A high priority queue will be handled before a low priority queue.

FIG. 7 illustrates example formats for the new request and confirmation primitives for isochronous data flows in accordance with various embodiments. The new request primitive MAC-ISOCH-DATA-POP.request comprises the fields “OrigID” and “StreamIndex” which both have already been discussed before. The new confirmation primitive MAC-ASYNC-DATA-POP.confirm comprises the fields “OrigID”, “StreamIndex”, “Length”, “Data”, and “ResultCode” which have also already been discussed before so that reference can be made to the foregoing explanations.

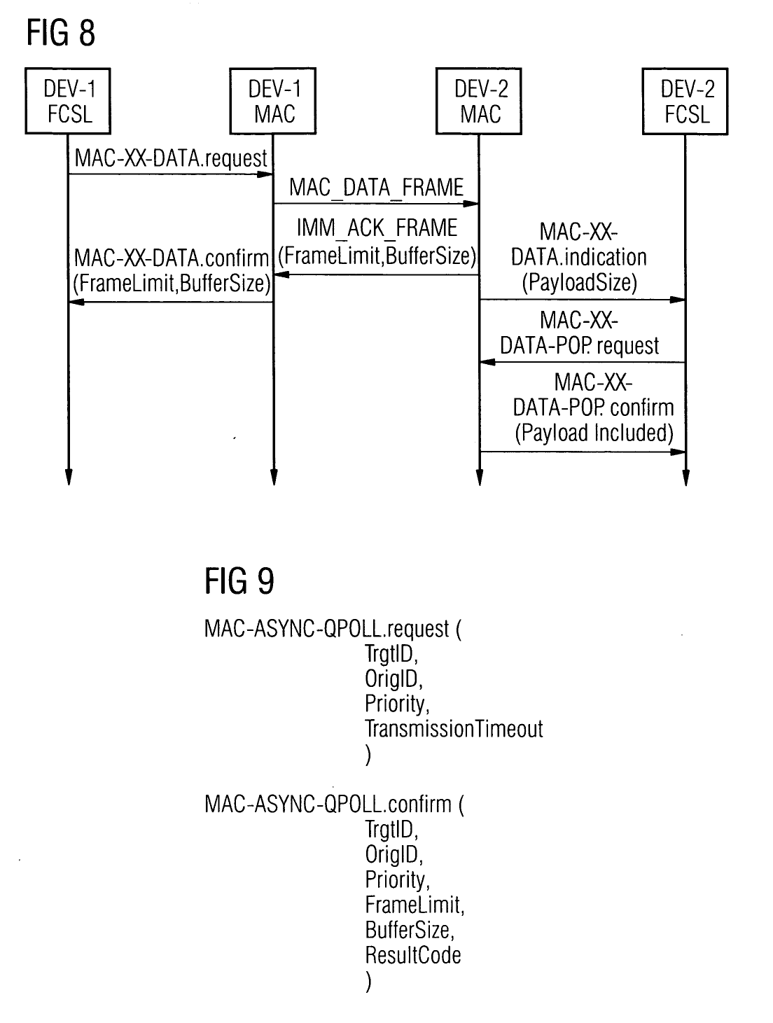

FIG. 8 illustrates an example for a MBOA MAC flow control mechanism according to one embodiment.

According to the illustrated embodiment of FIG. 8, it is assumed that communication frames are transmitted from a first communication device DEV-1 (transmitting device) to a second communication device DEV-2 (receiving device). A communication data frame MAC_DATA_FRAME is transmitted from the MAC layer of the communication device DEV-1 to the MAC layer of the communication device DEV-2. The MAC layer of the communication device DEV-2 informs the FCSL (frame convergence sub layer) of the communication device DEV-2 when the new data frame has arrived by using the MAC-XX-DATA.indication primitive including information on the payload size of the received data frame. Thereafter, the FCSL of the communication device DEV-2 requests the respective communication frame from the queue of the communication device DEV-2 by using the MAC-XX-DATA-POP.request primitive, and the MAC layer of the communication device DEV-2 transmits the data, that is the payload included in the received communication frame, to the FCSL of the communication device DEV-2 by using the MAC-XX-DATA-POP.confirm primitive.

Furthermore, as illustrated in FIG. 8, the MAC layer of the communication device DEV-2 (receiving device) transmits an immediate frame acknowledgement notification IMM_ACK_FRAME, including the parameters “FrameLimit” and “BufferSize” to the MAC layer of the transmitting communication device DEV-1. The transmitting application of the communication device DEV-1 can use the “FrameLimit” and “BufferSize” parameters to change the transmission rate according to the ability of the receiving communication device DEV-2 to empty its MAC buffers. The MAC layer of the transmitting communication device DEV-1 informs the FCSL of the communication device DEV-1 on the “FrameLimit” and “BufferSize” parameters by using the MAC-XX-DATA.confirm primitive.

The above-described mechanism can be combined with a queue polling scheme. Queue polling allows the networking higher layers above the MAC layer at the transmitting side to check the status of specific queues at the receiving side. Also, the transmitting MAC layer can use queue polling to resolve flow-off situations. A flow-off situation is a case where the parameter “BufferSize”=0 was received in an acknowledgement frame. The MAC layer or higher layers can poll the full queue to check when it is possible to send additional frames to it. Queue polling can also be used as a flow control mechanism for no-acknowledgement flows. It enables the checking of the most recent status of each queue without actually sending data traffic to the receiving side.

For asynchronous data flows, example embodiments of new MAC-SAP queue polling primitives illustrated in FIG. 9 can be used. These new MAC-SAP queue polling primitives include a queue polling request primitive MAC-ASYNC-QPOLL.request and a queue polling confirmation primitive MAC-ASYNC-QPOLL.confirm. The parameters “TrgtID”, “OrigID”, “Priority”, “FrameLimit”, “BufferSize”, and “ResultCode” have already been discussed before with respect to the flow control primitives illustrated in FIGS. 4-7. As regards these parameters, reference can be made to the above explanations. In addition, the request primitive includes the parameter “TransmissionTimeout” which defines the duration of time the respective request will stay valid until a confirmation is received. If no confirmation to the request is received by the time stated in this parameter, the operation will halt, and the polling MAC layer has to handle this situation either by performing another request or other tasks.

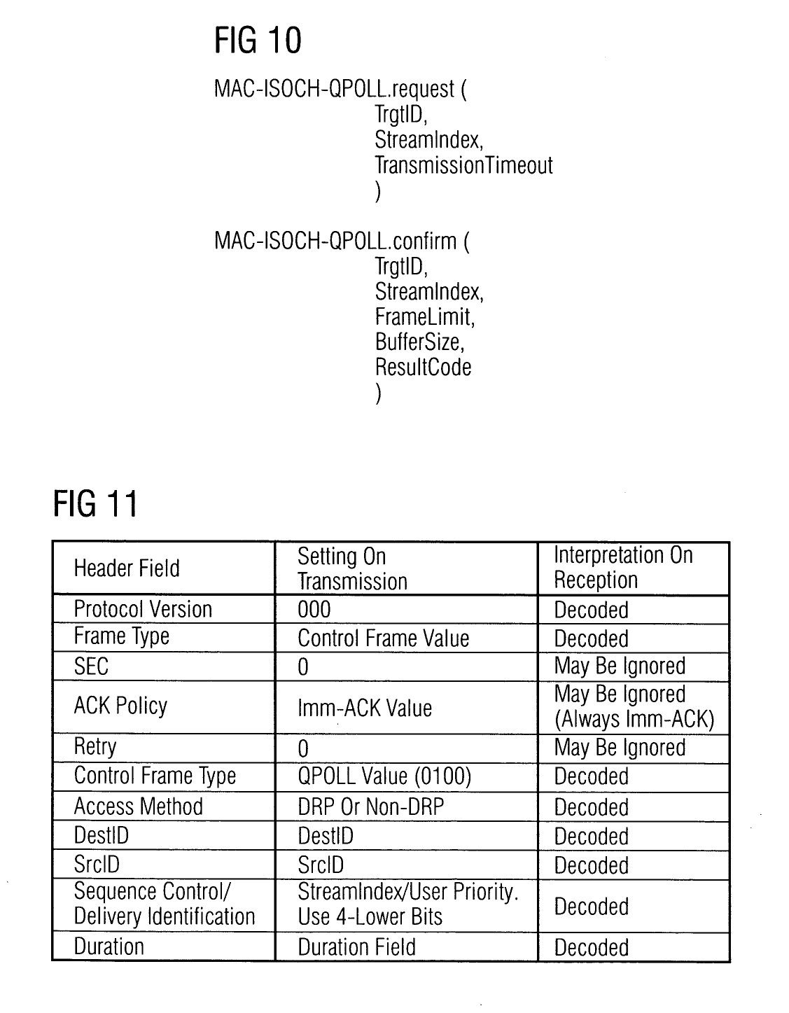

FIG. 10 illustrates respective example embodiments of primitives MAC-ISOCH-QPOLL.request and MAC-ISOCH-QPOLL.confirm for isochronous data flows. All the parameters illustrated in FIG. 10 have already been explained before.

The queue polling request primitives initiate the generation of a queue polling control frame from the transmitting MAC layer to the receiving MAC layer. The queue polling confirmation primitives are generated by the transmitting MAC layer to its higher layers upon reception of an immediate acknowledgement frame that was received after a queue polling control frame was sent. The immediate acknowledgement buffer size is indicated in the respective primitive.

For MAC-SAP flow control, a new control frame has to be defined in the MBOA MAC layer. This frame is the queue polling control frame. An example format of the queue polling control frame of one embodiment is illustrated in FIG. 11.

Most of the control fields of the control frame illustrated in FIG. 11 have already been discussed before with respect to FIG. 2 and FIG. 3 so that reference can be made to the explanations with respect to FIG. 2 and FIG. 3. However, the format of the queue polling control frame includes an additional field “Control Frame Type” which indicates the type of the control frame and, in the present case, is transmitted with the value “0100” corresponding to a queue polling value and indicating a queue polling control frame. Furthermore, the queue polling control frame includes a field “Sequence Control/Delivery identification” which is transmitted with the value of the “StreamIndex” parameter and the “User Priority” parameter, the four lower bits being used for this control field. As already discussed before, for frames that use the non-DRP allocation type, it is possible to support different queues between the same communication devices. The individual queues correspond to different application priorities, meaning that a high priority queue will be handled before a low priority queue. The “User Priority” parameter differentiates between different data flows that belong to the same transmitting and receiving device. Furthermore, the queue polling control frame includes the field “Duration” indicating the duration of the queue polling control frame.

It is also possible to support queue polling originating in the DME (device management entity) of the transmitting device. It can be implemented, for example, in case MAC-SAP queue polling is not desired.

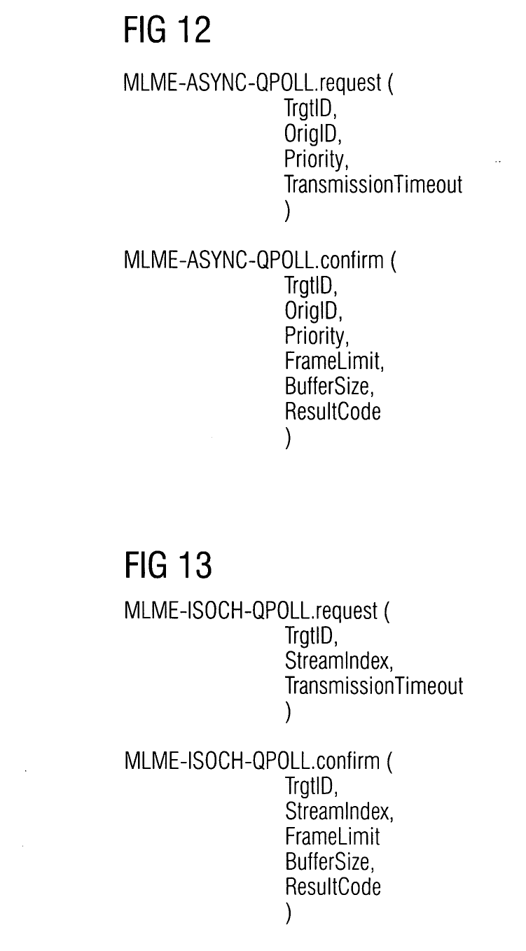

FIG. 12 illustrates an example format of the queue polling request primitive MLME-ASYNC-QPOLL.request and the queue polling confirmation primitive MLME-ASYNC.QPOLL.confirm for asynchronous data flows according to one embodiment.

Furthermore, FIG. 13 illustrates an example queue polling request primitive MLME-ISOCH-QPOLL.request and the queue polling confirmation primitive MLME-ISOCH-QPOLL.confirm for isochronous data flows according to one embodiment.

The parameters of the primitives illustrated in FIG. 12 and FIG. 13 have already been discussed before.

The queue polling request primitives initiate the generation of a queue polling command frame from the transmitting MAC layer to the receiving MAC layer. The queue polling confirmation primitives are generated by the transmitting MAC layer to its higher layers upon reception of an immediate acknowledgement frame that was received after a queue polling command frame was sent. The immediate acknowledgement buffer size is indicated in the primitive.

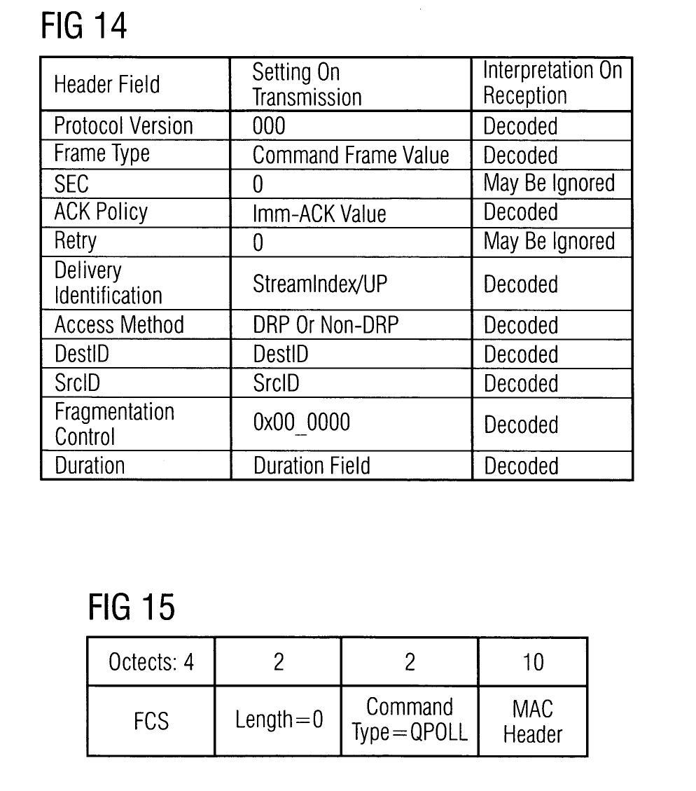

For MLME-SAP flow control, a new command frame has to be defined in the MBOA MAC layer. This frame is the queue polling command frame. An example format of the queue polling command frame of one embodiment is illustrated in FIG. 14.

As illustrated in FIG. 14, the queue polling command frame includes a field “Delivery Identification” which, again, is transmitted with the “StreamIndex”/“User Priority” parameter values. Furthermore, the queue polling command frame includes a field “Fragmentation Control” which can be used to control the fragmentation during the communication process.

FIG. 15 illustrates an example format of a queue polling command frame in terms of the octet structure, and four octets are used as a frame check sequence (FCS), while two octets are used to indicate a data length of “0”, two further octets being used to define the command type as a queue polling command type (QPOLL) according to one embodiment. Finally, the example queue polling command frame format includes ten octets for the MAC header illustrated in FIG. 14.

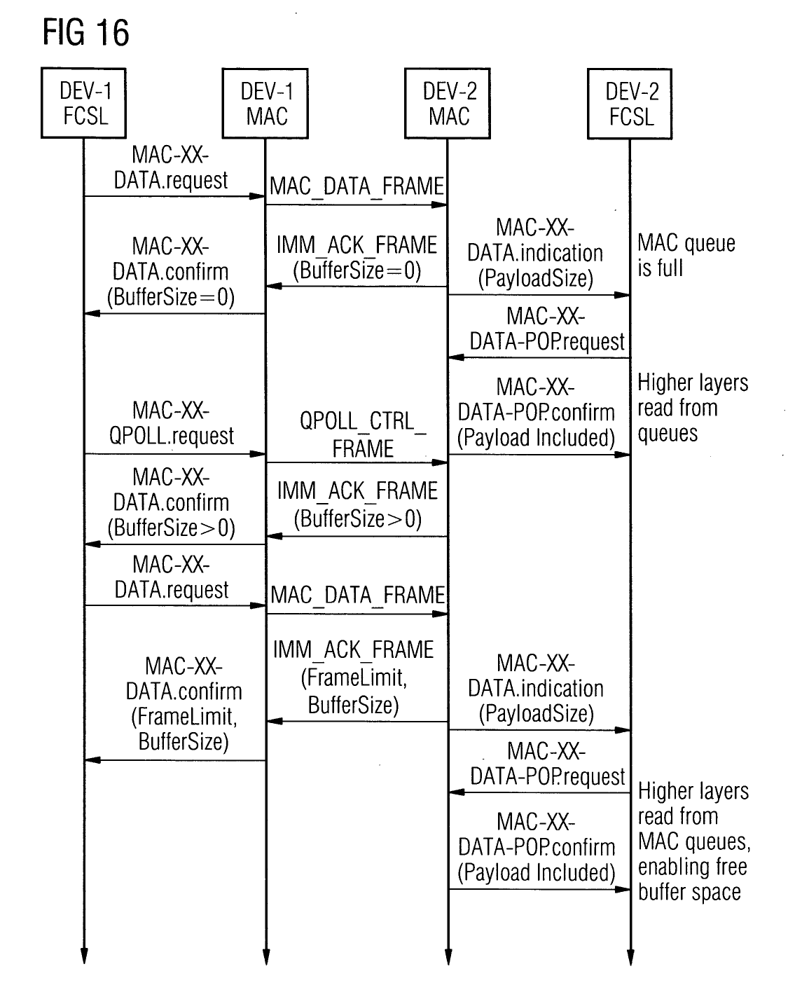

FIG. 16 illustrates one embodiment of data flow between a transmitting communication device DEV-1, in particular the FCSL and MAC layers of the transmitting communication device DEV-1, and the respective layers of a receiving communication device DEV-2.

The beginning of the data flow illustrated in FIG. 16 is similar to the data flow illustrated in FIG. 8 with respect to the transmission of the immediate acknowledgement frame, however assuming that a buffer size of “0” is transmitted from the MAC layer of the communication device DEV-2 to the MAC layer of the communication device DEV-1, since the MAC queue of the receiving communication device DEV-2 is assumed to be full.

After having received the information on the full MAC queue of the communication device DEV-2, the FCSL of the communication device DEV-1 sends a queue polling request to its MAC layer using an MAC-XX-QPOLL.request primitive, and the MAC layer of the communication device DEV-1 sends a queue polling control frame QPOLL_CTRL_Frame to the MAC layer of the communication device DEV-2 to check the status of the individual queues of the communication device DEV-2. As soon as the MAC layer of the communication device DEV-1 thereafter receives an immediate acknowledgement frame indicating a buffer size >“0”, the MAC layer of the communication device DEV-1 informs the FCSL of the communication device DEV-1 of the available buffer size by using the confirmation primitive MAC-XX-DATA.confirm. Thereafter, the same process starts again as already discussed before with respect to FIG. 8.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of transmitting information in a communication system, the method comprising:
transmitting information from a transmitting device to a receiving device through a communication channel;
checking whether the receiving device has received the information without errors; and
transmitting an acknowledgement notification from the receiving device to the transmitting device if the receiving device has received the information without errors, wherein the acknowledgement notification comprises an indication of a capability of the receiving device to receive further information from the transmitting device.

2. The method of claim 1, wherein the acknowledgement notification is transmitted from the receiving device to the transmitting device if a frame of information has been received by the receiving device without errors.

3. The method of claim 2, wherein the acknowledgement notification is transmitted from the receiving device to the transmitting device as an immediate acknowledgement frame notification.

4. The method of claim 2, wherein the acknowledgement notification is transmitted from the receiving device to the transmitting device as a burst acknowledgement frame notification.

5. The method of claim 1, wherein the acknowledgement notification comprises information on a maximum number of additional frames which can be received by the receiving device from the transmitting device.

6. The method of claim 1, wherein the acknowledgement notification comprises information on a free buffer size of the receiving device available for receiving further information from the transmitting device.

7. The method of claim 1, comprising:
checking the capability of the receiving device to receive further information by the transmitting device.

8. The method of claim 7, comprising:
transmitting a queue polling request from the transmitting device to the receiving device to check a queue status of the receiving device.

9. The method of claim 8, wherein the queue polling request is transmitted by a media access controller layer of the transmitting device.

10. The method of claim 8, wherein the acknowledgement notification is transmitted from the transmitting device to the receiving device after having received the queue polling request and having checked the status of at least one queue of the receiving device.

11. The method of claim 1, further comprising:
transmitting a result of the checking from the receiving device to the transmitting device.

12. A communication system, comprising
a communication channel;
a transmitting device coupled to the communication channel and configured to transmit information through the communication channel; and
a receiving device coupled to the communication channel and configured to receive the information transmitted from the transmitting device through the communication channel, the receiving device configured to check whether the receiving device has received the transmitted information from the transmitting device without errors and to send an acknowledgement notification to the transmitting device if the transmitted information is received without errors, wherein the acknowledgement notification comprises an indication of a capability of the receiving device to receive further information from the transmitting device.

13. The communication system of claim 12, wherein the receiving device is configured to transmit the acknowledgement notification to the transmitting device as an immediate acknowledgement frame notification.

14. The communication system of claim 12, wherein the receiving device is configured to transmit the acknowledgement notification to the transmitting device as a burst acknowledgement frame notification.

15. The communication system of claim 12, wherein the acknowledgement notification comprises information on a maximum number of additional frames which can be received by the receiving device from the transmitting device.

16. The communication system of claim 12, wherein the acknowledgement notification comprises information on a free buffer size of the receiving device available for receiving further information from the transmitting device.

17. The communication system of claim 12, wherein the communication system is a communication system according to the ultra-wideband technology.

18. The communication system of claim 12, wherein the communication system is a communication system according to the multiband OFDM alliance standard.

19. The communication system of claim 12, wherein the receiving device comprises a media access controller layer configured to transmit the acknowledgement notification.

20. The communication system of claim 19, wherein the transmitting device comprises higher layers configured to receive the acknowledgement notification transmitted by the media access control layer of the receiving device.

21. A communication system, comprising
a communication channel;
means for transmitting information through the communication channel; and
means for receiving the information transmitted through the communication channel, including:
means for checking whether the receiving device has received the transmitted information from the transmitting device without errors; and
means for sending an acknowledgement notification to the transmitting device if the transmitted information is received without errors, wherein the acknowledgement notification comprises an indication of a capability of the receiving device to receive further information from the transmitting device.

22. A receiving device comprising:
a receiver unit configured to receive information from a transmitting device through a communication channel;
a control unit configured to check whether the receiving device has received the transmitted information from the transmitting device without errors; and
a sender unit configured to send an acknowledgement notification to the transmitting device if the transmitted information is received without errors, wherein the acknowledgement notification comprises an indication of a capability of the receiving device to receive further information from the transmitting device.

23. The receiving device of claim 22, comprising:
a transceiver unit including the receiver unit and the sender unit.

24. A receiving device comprising:
means for receiving information from a transmitting device through a communication channel;
means for checking whether the receiving device has received the transmitted information from the transmitting device without errors; and
means for sending an acknowledgement notification to the transmitting device if the transmitted information is received without errors, wherein the acknowledgement notification comprises an indication of a capability of the receiving device to receive further information from the transmitting device.
